(19) United States
(12) Patent Application Publication
(10) Pub. No.: US 2025/0056653 A1
(43) Pub. Date: Feb. 13, 2025

(54) CONFIGURATION FOR TIMING OF CELL DISCONTINUOUS TRANSMISSION OR RECEPTION

(71) Applicant: QUALCOMM Incorporated, San Diego, CA (US)

(72) Inventors: Ahmed Attia ABOTABL, San Diego, CA (US); Diana MAAMARI, San Diego, CA (US); Sherif ELAZZOUNI, San Diego, CA (US)

(21) Appl. No.: 18/446,336

(22) Filed: Aug. 8, 2023

(51) Int. Cl. H04W 76/28; H04W 72/232

(52) U.S. Cl. CPC H04W 76/28; H04W 72/232

(57) ABSTRACT

Various aspects of the present disclosure generally relate to wireless communication. In some aspects, a user equipment (UE) may receive a configuration that indicates a timing of a cell discontinuous transmission (DTX) or discontinuous reception (DRX) of a network entity. The UE may receive an activation downlink control information (DCI) for the cell DTX or DRX. The UE may apply the configuration based at least in part on receiving the activation DCI. Numerous other aspects are described.

### INTRODUCTION

Aspects of the present disclosure generally relate to wireless communication and to techniques and apparatuses for cell discontinuous transmission or reception.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed at a user equipment (UE). The method may include receiving a configuration that indicates a timing of a cell discontinuous transmission (DTX) or discontinuous reception (DRX) of a network entity. The method may include receiving an activation downlink control information (DCI) for the cell DTX or DRX. The method may include applying the configuration based at least in part on receiving the activation DCI.

Some aspects described herein relate to a method of wireless communication performed at a network entity. The method may include transmitting a configuration that indicates a timing of a cell DTX or DRX of the network entity. The method may include transmitting an activation DCI for the cell DTX or DRX.

Some aspects described herein relate to a UE for wireless communication. The UE may include one or more memories and one or more processors coupled to the one or more memories. The one or more processors may be configured to cause the UE to receive a configuration that indicates a timing of a cell DTX or DRX of a network entity. The one or more processors may be configured to cause the UE to receive an activation DCI for the cell DTX or DRX. The one or more processors may be configured to cause the UE to apply the configuration based at least in part on receiving the activation DCI.

Some aspects described herein relate to a network entity for wireless communication. The network entity may include one or more memories and one or more processors coupled to the one or more memories. The one or more processors may be configured to cause the network entity to transmit a configuration that indicates a timing of a cell DTX or DRX of the network entity. The one or more processors may be configured to cause the network entity to transmit an activation DCI for the cell DTX or DRX.

Some aspects described herein relate to a non-transitory computer-readable medium that stores a set of instructions for wireless communication by a UE. The set of instructions, when executed by one or more processors of the UE, may cause the UE to receive a configuration that indicates a timing of a cell DTX or DRX of a network entity. The set of instructions, when executed by one or more processors of the UE, may cause the UE to receive an activation DCI for the cell DTX or DRX. The set of instructions, when executed by one or more processors of the UE, may cause the UE to apply the configuration based at least in part on receiving the activation DCI.

Some aspects described herein relate to a non-transitory computer-readable medium that stores a set of instructions for wireless communication by a network entity. The set of instructions, when executed by one or more processors of the network entity, may cause the network entity to transmit a configuration that indicates a timing of a cell DTX or DRX of the network entity. The set of instructions, when executed by one or more processors of the network entity, may cause the network entity to transmit an activation DCI for the cell DTX or DRX.

Some aspects described herein relate to an apparatus for wireless communication. The apparatus may include means for receiving a configuration that indicates a timing of a cell DTX or DRX of another apparatus. The apparatus may include means for receiving an activation DCI for the cell DTX or DRX. The apparatus may include means for applying the configuration based at least in part on receiving the activation DCI.

Some aspects described herein relate to an apparatus for wireless communication. The apparatus may include means for transmitting a configuration that indicates a timing of a cell DTX or DRX of the apparatus. The apparatus may include means for transmitting an activation DCI for the cell DTX or DRX.

Aspects generally include a method, apparatus, system, computer program product, non-transitory computer-readable medium, user equipment, base station, network entity, network node, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example associated with a timing of a cell discontinuous transmission or discontinuous reception, in accordance with the present disclosure.

FIG. 5 is a diagram illustrating an example of using an application delay, in accordance with the present disclosure.

FIG. 6 is a diagram illustrating an example of a deactivation downlink control information, in accordance with the present disclosure.

FIG. 7 is a diagram illustrating an example of a start and length indicator value, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a network entity or an apparatus of a network entity, in accordance with the present disclosure.

FIG. 10 is a diagram of an example apparatus for wireless communication, in accordance with the present disclosure.

FIG. 11 is a diagram illustrating an example of a hardware implementation for an apparatus employing a processing system, in accordance with the present disclosure.

FIG. 12 is a diagram illustrating an example of an implementation of code and circuitry for an apparatus, in accordance with the present disclosure.

FIG. 13 is a diagram of an example apparatus for wireless communication, in accordance with the present disclosure.

FIG. 14 is a diagram illustrating an example of a hardware implementation for an apparatus employing a processing system, in accordance with the present disclosure.

FIG. 15 is a diagram illustrating an example of an implementation of code and circuitry for an apparatus, in accordance with the present disclosure.

### DETAILED DESCRIPTION

Various aspects relate generally to wireless communication and more particularly to network energy conservation. Energy consumption is a large percentage of network costs, and most network energy consumption comes from a radio access network (RAN). A network entity (e.g., gNB) may operate to conserve power. Network energy conservation may help with the adoption and expansion of cellular networks. In some examples, to conserve energy, a network entity may use a cell discontinuous transmission (DTX) mode. DTX includes periodic DTX cycles, where each DTX cycle includes an active duration during which the network entity uses power for transmission and an inactive duration during which the network entity reduces its power and does not transmit signals (or does not transmit certain signals). The network entity may also use a cell DRX mode that includes periodic DRX cycles, where each DRX cycle includes an active duration during which the network entity uses power for monitoring and reception and an inactive duration during which the network entity reduces its power and does not monitor for and receive signals (or does not receive certain signals).

In some examples, when the network entity is in an inactive duration, the network entity may enter a sleep state. Sleeping may involve turning off a radio and one or more other components or functions. Turning off or switching off a radio may include removing power from the radio such that the radio is not fully operating or not operating with full power. The network entity may wake up for an active duration. Waking up may involve turning on a radio and one or more other components or functions. Turning on or switching on a radio may include adding power to the radio such that the radio is fully operating or operating with full power. A user equipment (UE) may also operate in a DRX mode. A UE may align its DRX cycle with that of the cell DRX cycle.

A network entity may transmit a group common downlink control information (DCI) (activation DCI) to activate a cell DTX and/or DRX of the network entity for one or more UEs. The UE may adhere to the cell DTX or DRX. Adhering to the cell DTX or DRX may include the UE assuming or expecting the cell DTX or DRX, or the UE communicating with respect to or in regard to the cell DTX or DRX. In an example, if the cell is in DRX mode, the UE may not transmit an uplink communication during an inactive duration of the cell DRX mode of the network entity, and the UE may transmit an uplink communication during an active duration of the cell DRX mode of the network entity. In another example, if the cell is in DTX mode, the UE may not monitor for or receive a downlink communication from the network entity during an inactive duration of the cell DTX mode, and the UE may monitor for and receive a downlink communication during an active duration of the cell DTX mode.

However, the cell DTX/DRX mode may be expected to end and thus the network entity may transmit another group common DCI (deactivation DCI) to deactivate the cell DTX/DRX mode, such that the UE no longer adheres to the cell DTX or DRX. Deactivating adherence to the cell DTX or DRX may include the UE no longer assuming or expecting the cell DTX or DRX, or the UE no longer communicating with respect to or in regard to the cell DTX or DRX. This deactivation DCI may increase signaling overhead.

According to various aspects described herein, a UE may know when to stop adhering to a cell DTX or DRX of a network entity without receiving a deactivation DCI from the network entity. In some aspects, the UE may receive a configuration for a timing of a cell DTX or DRX. The configuration may indicate the timing. The timing may include when the cell DTX or DRX is activated or deactivated. The UE may apply the configuration for the timing. The UE may apply the configuration by adhering to the cell DTX or DRX, or more specifically, by adhering to the timing of the cell DTX or DRX. For example, the configuration may deactivate the UE's adherence to the cell DTX or DRX after a quantity of slots from the slot from when the UE receives an activation DCI that activates adherence to the cell DTX or DRX. In an example, the configuration may deactivate the UE's adherence to the cell DTX or DRX after a quantity of symbols from the symbol when the UE receives the activation DCI. In another example, the configuration may deactivate adherence to the cell DTX or DRX at an absolute time. In yet another example, the configuration may deactivate adherence to the cell DTX or DRX after expiration of a timer.

In some examples, by configuring a UE with a timing of a cell DTX or DRX, the UE may deactivate adherence to the cell DTX or DRX without the network entity transmitting a deactivation DCI. As a result, the network entity conserves signaling resources. The UE may conserve signaling resources and processing resources by not receiving and processing a deactivation DCI.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

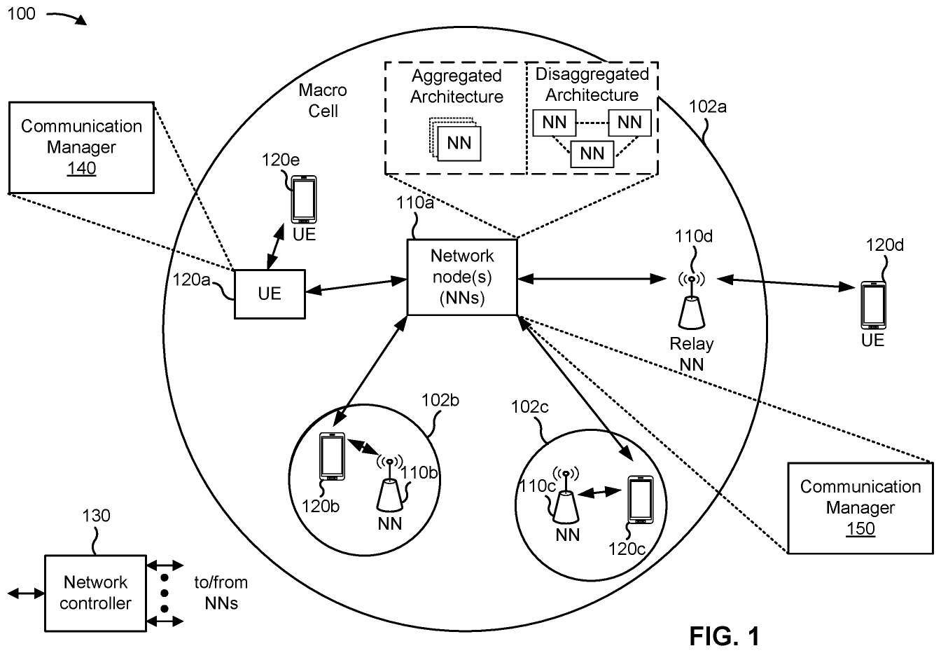

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (MTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

The electromagnetic spectrum is often subdivided, by frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., a UE 120) may include a communication manager 140. As described in more detail elsewhere herein, the communication manager 140 may receive a configuration that indicates a timing of a cell DTX or DRX of a network entity. The communication manager 140 may receive an activation DCI for the cell DTX or DRX. The communication manager 140 may apply the configuration based at least in part on receiving the activation DCI. Additionally, or alternatively, the communication manager 140 may perform one or more other operations described herein.

In some aspects, a network entity (e.g., a network node 110) may include a communication manager 150. As described in more detail elsewhere herein, the communication manager 150 may transmit a configuration that indicates a timing of a cell DTX or DRX. The communication manager 150 may transmit an activation DCI for the cell DTX or DRX. Additionally, or alternatively, the communication manager 150 may perform one or more other operations described herein.

As indicated above, FIG. 1 is provided as an example. Other examples may differ from what is described with regard to FIG. 1.

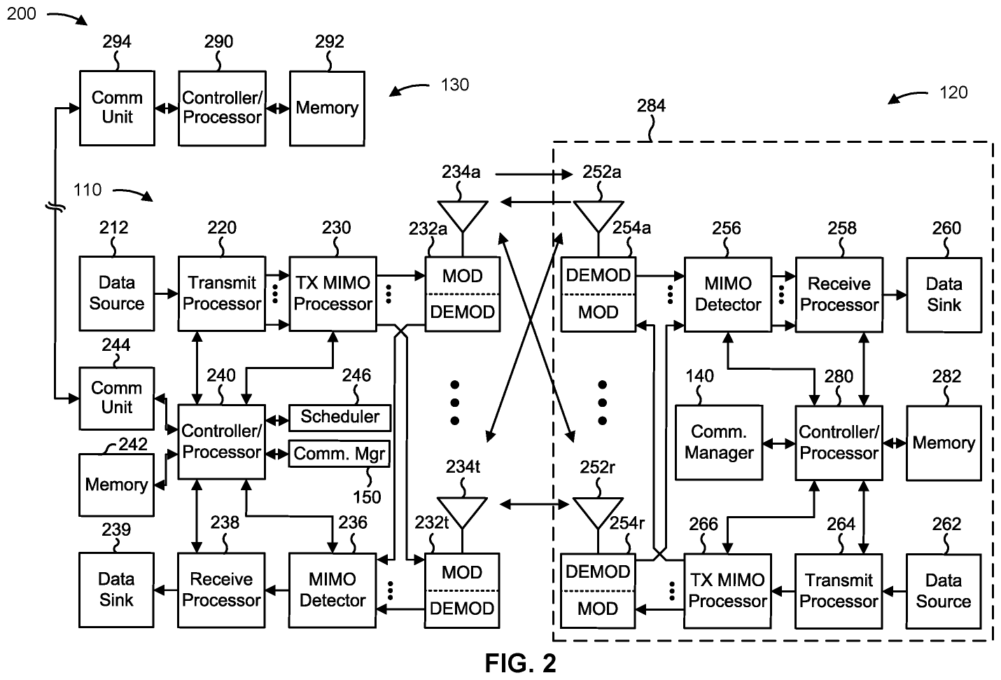

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

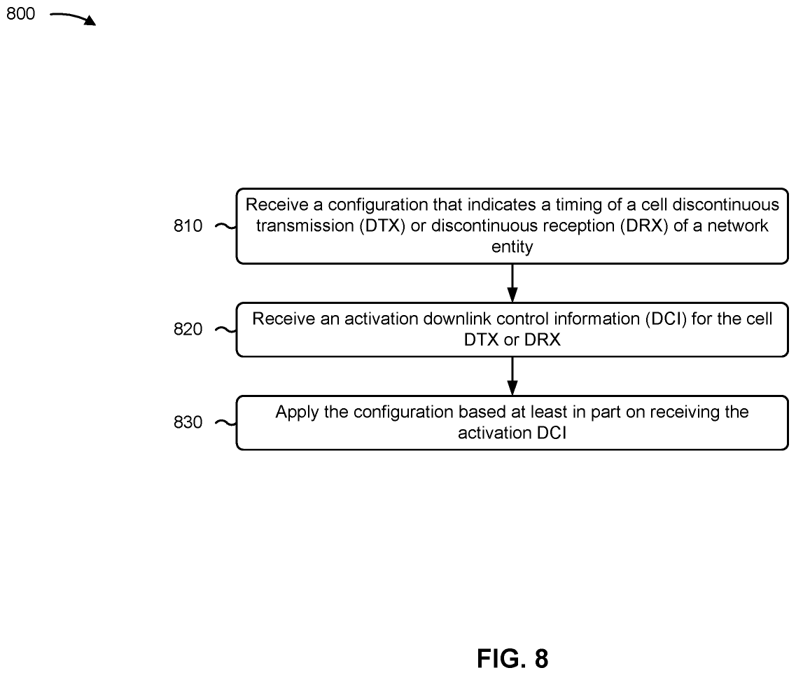

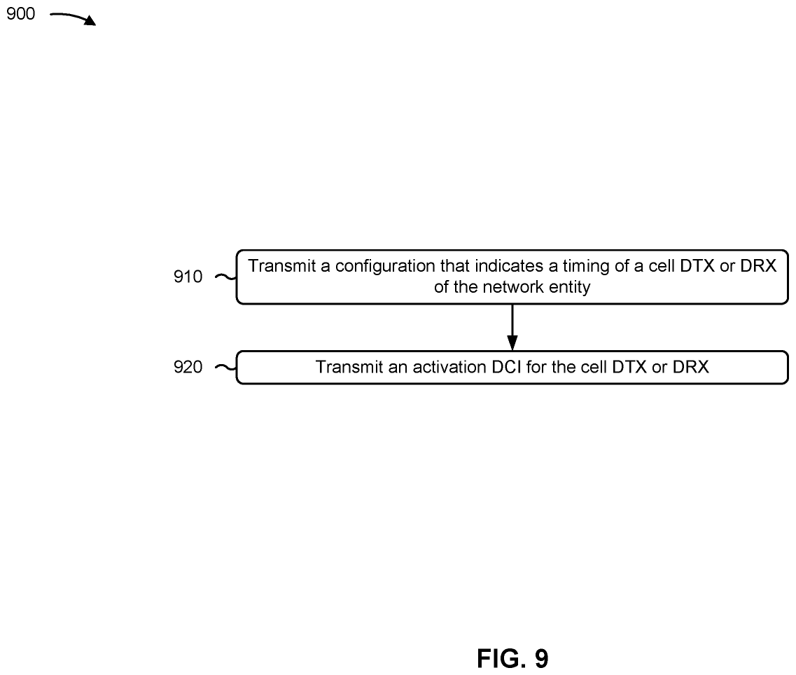

The controller/processor 240 of the network node 110, the controller/processor 280 of the UE 120, and/or any other component(s) of FIG. 2 may perform one or more techniques associated with a timing of a cell DTX or DRX, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a UE (e.g., a UE 120) includes means for receiving a configuration that indicates a timing of a cell DTX or DRX of a network entity; means for receiving an activation DCI for the cell DTX or DRX; and/or means for applying the configuration based at least in part on receiving the activation DCI. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., a network node 110) includes means for transmitting a configuration that indicates a timing of a cell DTX or DRX of the network entity; and/or means for transmitting an activation DCI for the cell DTX or DRX. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

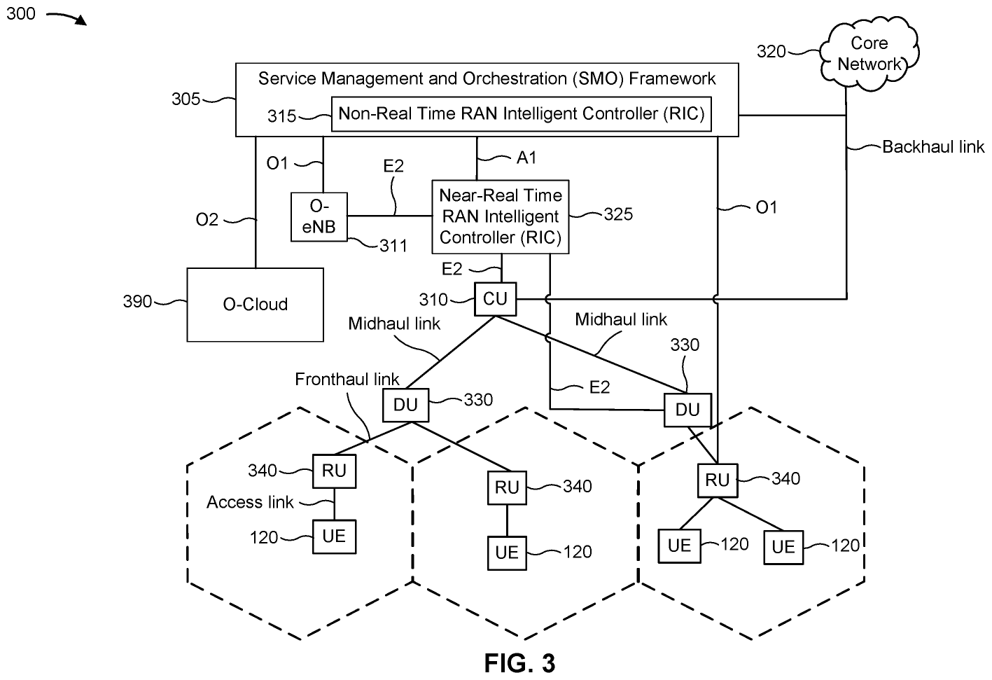

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-CNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-cNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

Energy consumption is a large percentage of network costs, and most network energy consumption comes from a RAN. A network entity (e.g., gNB) may operate to conserve power. Network energy conservation may help with the adoption and expansion of cellular networks. In some examples, to conserve energy, a network entity may use a cell discontinuous transmission (DTX) mode. DTX includes periodic DTX cycles, where each DTX cycle includes an active duration during which the network entity uses power for transmission and an inactive duration during which the network entity reduces its power and does not transmit signals (or does not transmit certain signals). The network entity may also use a cell DRX mode that includes periodic DRX cycles, where each DRX cycle includes an active duration during which the network entity uses power for monitoring and reception and an inactive duration during which the network entity reduces its power and does not monitor for and receive signals (or does not receive certain signals).

In some examples, when the network entity is in an inactive duration, the network entity may enter a sleep state. Sleeping may involve turning off a radio and one or more other components or functions of the network entity. Turning off or switching off a radio may include removing power from the radio such that the radio is not fully operating or operating with full power. The network entity may wake up for an active duration. Waking up may involve turning on a radio and one or more other components or functions of the network entity. Turning on or switching on a radio may include adding power to the radio such that the radio is fully operating or operating with full power. UEs may also operate in a DRX mode. A UE may align its DRX cycle with that of the cell DRX cycle.

A network entity may transmit a group common DCI (activation DCI) to activate a cell DTX and/or DRX for one or more UEs. The UE may adhere to the cell DTX or DRX. Adhering to the cell DTX or DRX may include the UE assuming or expecting the cell DTX or DRX, or the UE communicating with respect to or in regard to the cell DTX or DRX. In an example, if the cell is in DRX mode, the UE may not transmit an uplink communication during an inactive duration of the cell DRX mode of the network entity, and the UE may transmit an uplink communication during an active duration of the cell DRX mode of the network entity. In another example, if the cell is in DTX mode, the UE may not monitor for or receive a downlink communication from the network entity during an inactive duration of the cell DTX mode, and the UE may monitor for and receive a downlink communication during an active duration of the cell DTX mode.

However, the cell DTX/DRX mode may be expected to end and thus the network entity may transmit another group common DCI (deactivation DCI) to deactivate the DTX/DRX mode, such that the UE no longer adheres to the cell DTX or DRX. Deactivating adherence to the cell DTX or DRX may include the UE no longer assuming or expecting the cell DTX or DRX or no longer communicating with respect to or in regard to the cell DTX or DRX. This deactivation DCI increases signaling overhead.

According to various aspects described herein, a UE may know when to stop adhering to a cell DTX or DRX of a network entity without receiving a deactivation DCI from the network entity. In some aspects, a UE may receive and apply a configuration for a timing of a cell DTX or DRX. The timing may include when the cell DTX or DRX is activated or deactivated. For example, the configuration may deactivate the cell DTX or DRX after a quantity of slots or symbols from when the UE receives an activation DCI that activates adherence to the cell DTX or DRX. In another example, the configuration may deactivate the cell DTX or DRX at an absolute time. In yet another example, the configuration may deactivate the cell DTX or DRX after expiration of a timer. In this way, the UE may deactivate adherence to the cell DTX or DRX without the network entity transmitting a deactivation DCI. As a result, the network entity conserves signaling resources.

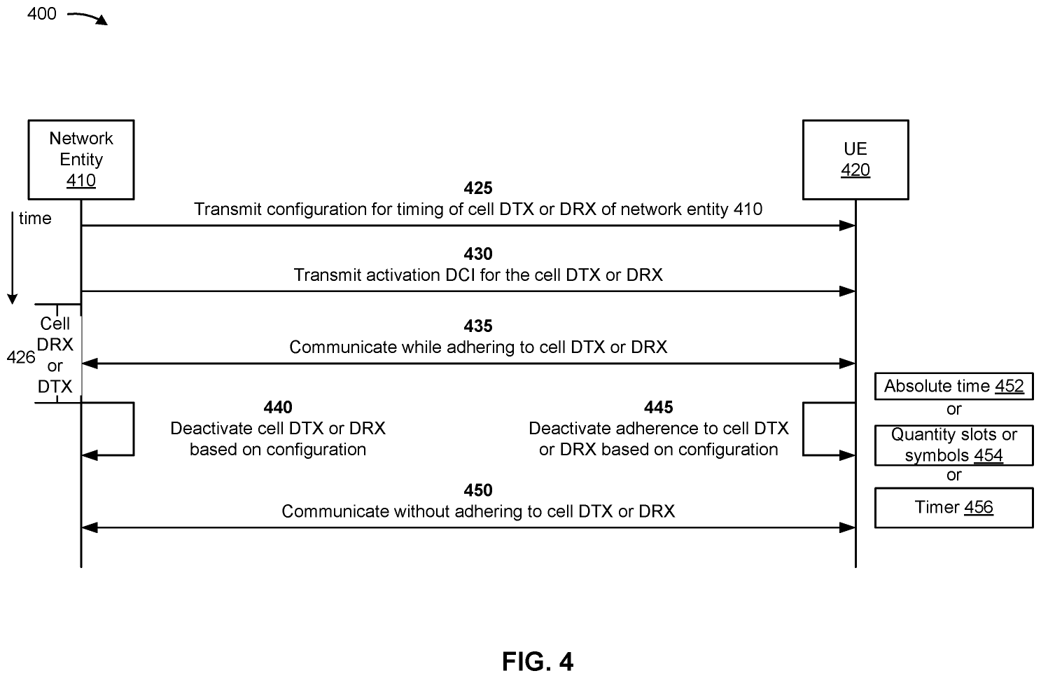

FIG. 4 is a diagram illustrating an example 400 associated with a timing of a cell DRX or DTX, in accordance with the present disclosure. As shown in FIG. 4, a network entity 410 (e.g., network node 110) and a UE 420 (e.g., UE 120) may communicate with one another via a wireless network (e.g., wireless network 100).

Example 400 shows a configuration for a timing of a cell DRX or DTX of the network entity 410. As shown by reference number 425, the network entity 410 may transmit a configuration for a timing of a cell DTX or DRX 426. In some aspects, the configuration may be an RRC configuration that is common for cell DTX configurations and cell DRX configurations. In some aspects, the configuration may be an RRC configuration that is common for cell DTX configurations or common for cell DRX configurations. In some aspects, the configuration may be an RRC configuration that is based at least in part on an activated cell DTX and DRX configuration, or a cell DTX or DRX that is activated by the network entity 410. In some aspects, the configuration may be included or indicated in the activation DCI. The UE 420 may receive the configuration that indicates the timing. In some aspects, the UE 420 may transmit a capability for being configured with a timing of a cell DTX or DRX.

As shown by reference number 430, the network entity 410 may transmit an activation DCI that activates adherence to the cell DTX or DRX 426. The network entity 410 may activate the cell DTX or DRX 426. The UE 420 may receive the activation DCI and start adhering to the cell DTX or DRX 426. As shown by reference number 435, the UE 420 may communicate while adhering to the cell DTX or DRX 426.

The configuration may indicate a timing of the cell DTX or DRX 426. The timing may include how long the cell DTX or DRX 426 is to last. As shown by reference number 440, the network entity 410 may deactivate the cell DTX or DRX 426 based at least in part on the timing that is indicated by the configuration. The UE 420 may apply the configuration. For example, as shown by reference number 445, the UE 420 may deactivate adherence to the cell DTX or DRX 426. In some aspects, if the UE 420 aligned a DRX of the UE 420 with the cell DTX during adherence to the cell DTX, the UE 420 may stop aligning the DRX of the UE 420 with the cell DTX. As shown by reference number 450, the UE 420 may communicate without adhering to the cell DTX or DRX 426.

The configuration may indicate the timing in different ways. In some aspects, the configuration may indicate an absolute time 452 at which the cell DTX or DRX 426 is to be deactivated. The absolute time 452 may be a time according to a synchronized clock, a subframe number, a slot index, or a symbol index. The UE 420 may stop adhering to the cell DTX or DRX 426 at the absolute time 452. In some aspects, the configuration may indicate a quantity of slots or symbols 454. The UE 420 may deactivate adherence to the cell DTX or DRX 426 the quantity of slots after a slot in which the activation DCI is received, after a subframe in which the activation DCI is received, or after an end of a monitoring occasion in which the activation DCI is received. The UE 420 may deactivate adherence to the cell DTX or DRX 426 the quantity of symbols after a symbol in which the activation DCI is received, after a subframe in which the activation DCI is received, or after an end of a monitoring occasion in which the activation DCI is received.

In some aspects, the configuration may indicate a timer 456 that starts with reception of the activation DCI. The timer 456 may have a preconfigured value or may be configured via RRC signaling. The UE 420 may apply the configuration by deactivating adherence to the cell DTX or DRX 426 based at least in part on expiration of the timer 456. In some aspects, the UE 420 may receive an activation DCI for another cell DTX or DRX and follow the same timer 456 for the other cell DTX or DRX. The UE 420 may deactivate adherence to the other cell DTX or DRX based at least in part on the expiration of the timer 456 (without resetting the timer 456). In some aspects, the UE 420 may reset the timer 456 (e.g., set the time to the timer value, set the symbol count to zero, or set the slot count to zero) based at least in part on reception of the activation DCI for the other cell DTX or DRX.

By using a configuration for a timing for deactivation of the cell DTX or DRX 426 (without use of a deactivation DCI), the network entity 410 may conserve signaling resources that would otherwise be consumed by multiple deactivation DCIs.

As indicated above, FIG. 4 is provided as an example. Other examples may differ from what is described with respect to FIG. 4.

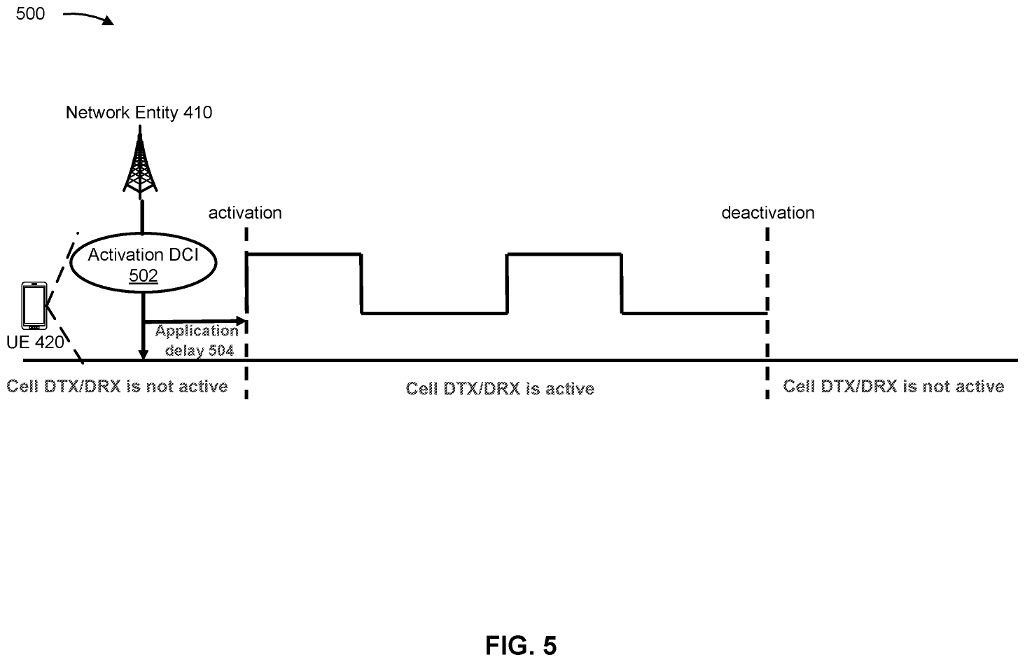

FIG. 5 is a diagram illustrating an example 500 of using an application delay, in accordance with the present disclosure.

In some aspects, upon receiving an activation DCI 502, a UE may start adhering to the cell DTX/DRX based at least in part on an application delay 504 for activation of the cell DTX or DRX. The configuration may indicate the application delay 504. Example 500 shows that the UE may apply the configuration by activating adherence to the cell DTX or DRX after the application delay 504. The UE may deactivate adherence to the cell DTX or DRX based at least in part on both the application delay 504 and the configuration. That is, the deactivation may follow the timing of the configuration, but the configuration may implement the timing after accounting for the application delay 504.

In some aspects, the application delay 504 may include a quantity of symbols or a quantity of slots. The application delay 504 may be RRC configured. In some aspects, the application delay 504 may be an offset that is indicated in the activation DCI 502 (or a deactivation DCI). In some aspects, the application delay 504 may be obtained from stored configuration information (specified in a standard). In some aspects, the application delay 504 may be based at least in part on a timer that starts with reception of the activation DCI 502. By using the application delay 504, a network entity may have more flexibility in starting a cell DTX or DRX and early signaling for starting the cell DTX or DRX. This may conserve signaling resources for a later time.

As indicated above, FIG. 5 is provided as an example. Other examples may differ from what is described with regard to FIG. 5.

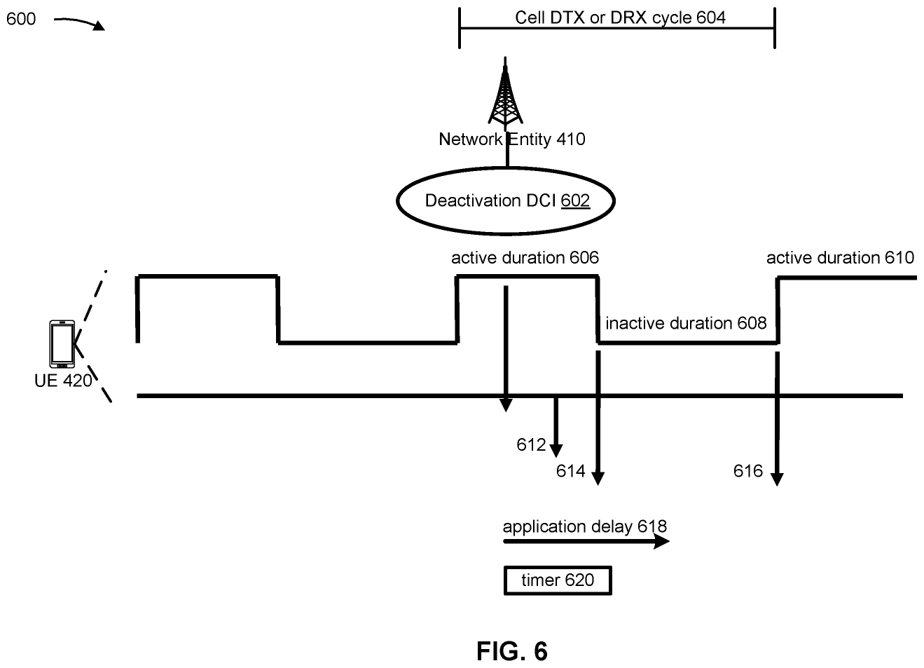

FIG. 6 is a diagram illustrating an example 600 of a deactivation DCI, in accordance with the present disclosure.

In some scenarios, the network entity may transmit a deactivation DCI 602. A network entity may transmit the deactivation DCI 602 during a DTX or DRX cycle 604. The DTX or DRX cycle may include an active duration 606 and an inactive duration 608. A next cycle may start with next active duration 610.

In some aspects, the UE may receive the deactivation DCI 602 and immediately deactivate adherence to the cell DTX or DRX (shown by time point 612). Immediate deactivation may include deactivation starting at a symbol or slot at which the deactivation DCI is completely decoded. Immediate deactivation may include deactivation before a scheduled end of the current active duration 606. In some aspects, deactivation may occur starting at an end of the current inactive duration 606 (shown by time point 614). In some aspects, deactivation may occur starting at the next active duration 610 (shown by time point 616). In some aspects, deactivation may occur after an application delay 618 from reception of the deactivation DCI 602. The network entity may transmit an indication of the application delay 618 or the application delay 618 may be obtained from stored configuration information (specified in a standard). In some aspects, deactivation may occur upon expiration of a timer 620 that starts when the deactivation DCI 602 is received. In some aspects, the application delay 618 may be configured similarly to the timer 620. These timing options described in connection with FIG. 6 may be indicated by a configuration of the timing of the cell DTX or DRX. By providing these options, the UE may know how to handle a timing of a deactivation DCI.

As indicated above, FIG. 6 is provided as an example. Other examples may differ from what is described with regard to FIG. 6.

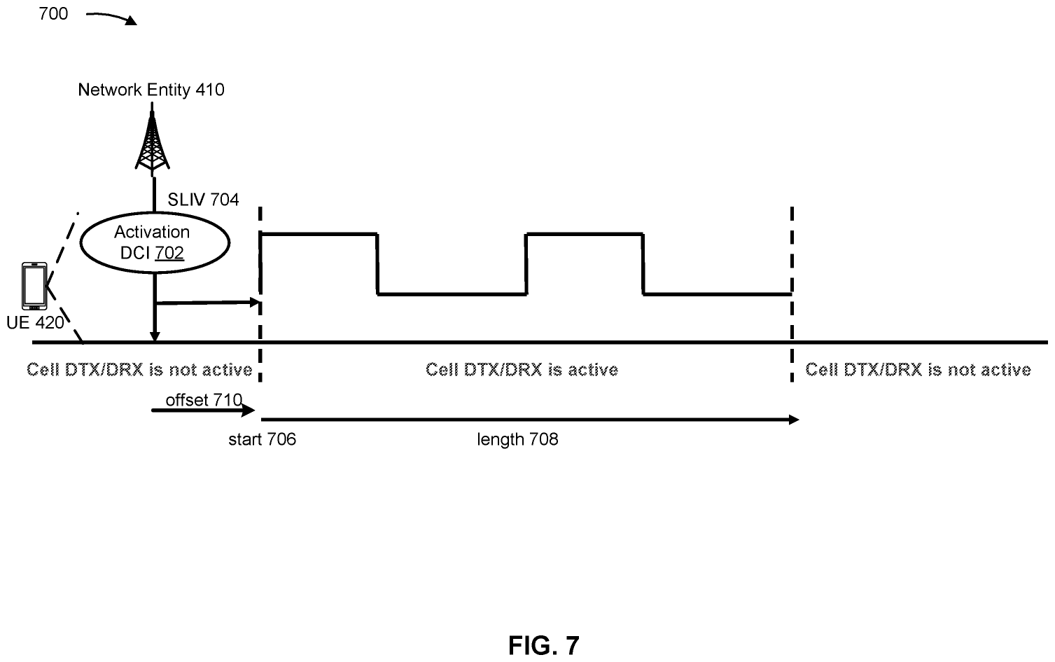

FIG. 7 is a diagram illustrating an example 700 of a start and length indicator value (SLIV), in accordance with the present disclosure.

Example 700 shows an activation DCI 702 for activation of a cell DTX or DRX. The activation DCI 702 may include an SLIV 704. The SLIV 704 may jointly indicate a start 706 of the activation and a length 708 of the activation. The start 706 may be an offset 710 after reception of the activation DCI 702. The activation DCI 702 may indicate the start 706 by indicating the offset 710. The scale of the offset 710 and the length 708 may be in symbols or slots. The quantity of the symbols or slots may configured at the UE via RRC signaling. In some aspects, the configuration may indicate the SLIV 704.

By using the SLIV 704 for the activation of a cell DTX or DRX, a network entity may have more flexibility in starting a cell DTX or DRX and early signaling for starting the cell DTX or DRX. This may conserve signaling resources for a later time.

As indicated above, FIG. 7 is provided as an example. Other examples may differ from what is described with regard to FIG. 7.

FIG. 8 is a diagram illustrating an example process 800 performed, for example, at a UE or an apparatus of a UE, in accordance with the present disclosure. Example process 800 is an example where the apparatus or the UE (e.g., UE 120, UE 420) performs operations associated with configurating a timing for cell DTX or DRX.

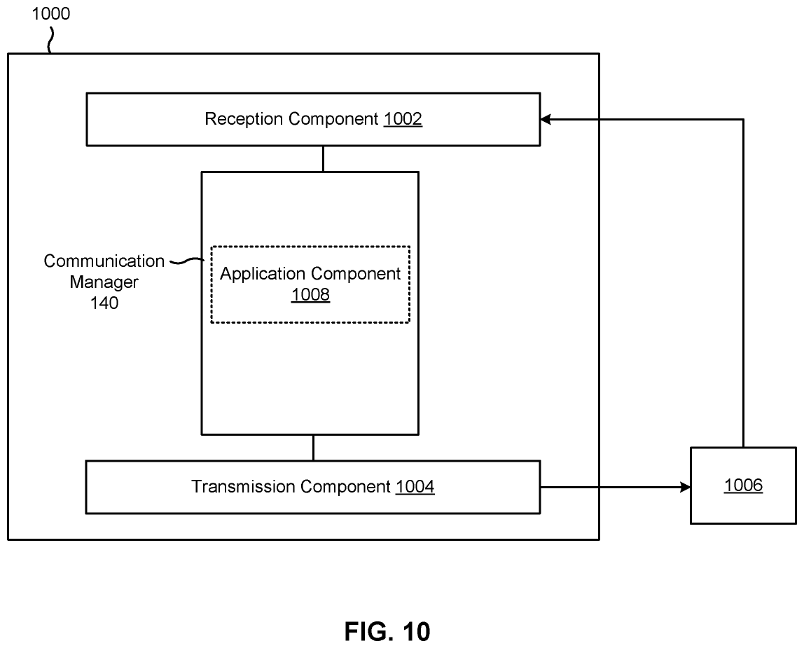

As shown in FIG. 8, in some aspects, process 800 may include receiving a configuration that indicates a timing of a cell DTX or DRX of a network entity (block 810). For example, the UE (e.g., using communication manager 140 and/or reception component 1002, depicted in FIG. 10) may receive a configuration that indicates a timing of a cell DTX or DRX of a network entity, as described above.

As further shown in FIG. 8, in some aspects, process 800 may include receiving an activation DCI for the cell DTX or DRX (block 820). For example, the UE (e.g., using communication manager 140 and/or reception component 1002, depicted in FIG. 10) may receive an activation DCI for the cell DTX or DRX, as described above.

As further shown in FIG. 8, in some aspects, process 800 may include applying the configuration based at least in part on receiving the activation DCI (block 830). For example, the UE (e.g., using communication manager 140 and/or application component 1008, depicted in FIG. 10) may apply the configuration based at least in part on receiving the activation DCI, as described above.

Process 800 may include additional aspects, such as any single aspect or any combination of aspects described below and/or in connection with one or more other processes described elsewhere herein.

In a first aspect, the configuration indicates an absolute time for deactivation of the cell DTX or DRX, and applying the configuration includes deactivating adherence to the cell DTX or DRX at the absolute time.

In a second aspect, alone or in combination with the first aspect, the configuration indicates a quantity of slots after the activation DCI for deactivation of the cell DTX or DRX, and applying the configuration includes deactivating adherence to the cell DTX or DRX after a slot in which the activation DCI is received, after a subframe in which the activation DCI is received, or after an end of a monitoring occasion in which the activation DCI is received.

In a third aspect, alone or in combination with one or more of the first and second aspects, the configuration indicates a quantity of symbols after the activation DCI for deactivation of the cell DTX or DRX, and applying the configuration includes deactivating adherence to the cell DTX or DRX the quantity of symbols after a symbol in which the activation DCI is received, after a subframe in which the activation DCI is received, or after an end of a monitoring occasion in which the activation DCI is received.

In a fourth aspect, alone or in combination with one or more of the first through third aspects, the configuration is an RRC configuration that is common for cell DTX configurations and cell DRX configurations.

In a fifth aspect, alone or in combination with one or more of the first through fourth aspects, the configuration is an RRC configuration that is common for cell DTX configurations or common for cell DRX configurations.

In a sixth aspect, alone or in combination with one or more of the first through fifth aspects, the configuration is an RRC configuration that is based at least in part on an activated cell DTX and DRX configuration.

In a seventh aspect, alone or in combination with one or more of the first through sixth aspects, the configuration is included in the activation DCI.

In an eighth aspect, alone or in combination with one or more of the first through seventh aspects, the configuration indicates a timer that starts with reception of the activation DCI, and applying the configuration includes deactivating adherence to the cell DTX or DRX based at least in part on expiration of the timer.

In a ninth aspect, alone or in combination with one or more of the first through eighth aspects, process 800 includes receiving an activation DCI for another cell DTX or DRX, and applying the configuration includes deactivating adherence to the other cell DTX or DRX based at least in part on the expiration of the timer.

In a tenth aspect, alone or in combination with one or more of the first through ninth aspects, process 800 includes receiving an activation DCI for another cell DTX or DRX, and resetting the timer based at least in part on reception of the activation DCI for the other cell DTX or DRX, where applying the configuration includes deactivating adherence to the other cell DTX or DRX based at least in part on the expiration of the timer.

In an eleventh aspect, alone or in combination with one or more of the first through tenth aspects, the configuration indicates a delay for activation of the cell DTX or DRX, and applying the configuration includes activating adherence to the cell DTX or DRX after the delay and deactivating adherence to the cell DTX or DRX based at least in part on the delay and the configuration.

In a twelfth aspect, alone or in combination with one or more of the first through eleventh aspects, the delay includes a quantity of slots or symbols.

In a thirteenth aspect, alone or in combination with one or more of the first through twelfth aspects, the delay includes an offset indicated in the activation DCI.

In a fourteenth aspect, alone or in combination with one or more of the first through thirteenth aspects, the delay is indicated in stored configuration information.

In a fifteenth aspect, alone or in combination with one or more of the first through fourteenth aspects, the delay is based at least in part on a timer that starts with reception of the activation DCI.

In a sixteenth aspect, alone or in combination with one or more of the first through fifteenth aspects, process 800 includes receiving a deactivation DCI, and immediately deactivating adherence to the cell DTX or DRX based at least in part on the deactivation DCI.

In a seventeenth aspect, alone or in combination with one or more of the first through sixteenth aspects, immediately deactivating adherence to the cell DTX or DRX include deactivating adherence to the cell DTX or DRX starting at a symbol or slot at which the deactivation DCI is decoded.

In an eighteenth aspect, alone or in combination with one or more of the first through seventeenth aspects, process 800 includes receiving a deactivation DCI, and deactivating adherence to the cell DTX or DRX starting at a next active duration and inactive duration of the cell DTX or DRX based at least in part on the deactivation DCI.

In a nineteenth aspect, alone or in combination with one or more of the first through eighteenth aspects, process 800 includes receiving a deactivation DCI, and deactivating adherence to the cell DTX or DRX starting at a next active duration of the cell DTX or DRX based at least in part on the deactivation DCI.

In a twentieth aspect, alone or in combination with one or more of the first through nineteenth aspects, process 800 includes receiving a deactivation DCI, and deactivating adherence to the cell DTX or DRX after an application delay from reception of the deactivation DCI.

In a twenty-first aspect, alone or in combination with one or more of the first through twentieth aspects, process 800 includes receiving a deactivation DCI, and deactivating adherence to the cell DTX or DRX based at least in part on the deactivation DCI and a timer.

In a twenty-second aspect, alone or in combination with one or more of the first through twenty-first aspects, the activation DCI includes an SLIV that indicates an offset after the activation DCI and a time length for activation of the cell DTX or DRX, and applying the configuration includes activating adherence to the cell DTX or DRX at the offset and deactivating adherence to the cell DTX and DRX after the time length.

In a twenty-third aspect, alone or in combination with one or more of the first through twenty-second aspects, at least one of the offset or the time length is based at least in part on a quantity of slots or a quantity of symbols configured for the UE.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network entity or an apparatus of a network entity, in accordance with the present disclosure. Example process 900 is an example where the apparatus or the network entity (e.g., network node 110, network entity 410) performs operations associated with configuring a timing for a cell DTX or DRX.

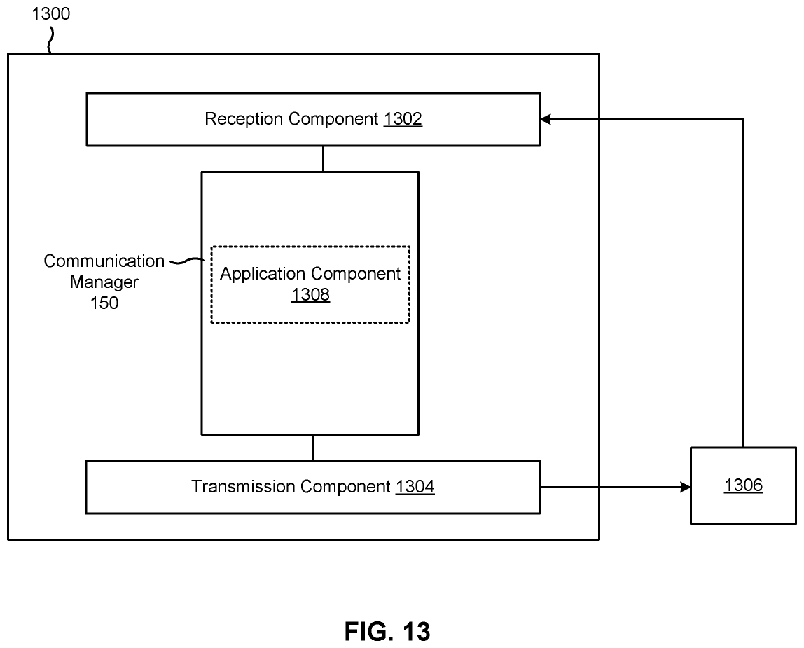

As shown in FIG. 9, in some aspects, process 900 may include transmitting a configuration that indicates a timing of a cell DTX or DRX of the network entity (block 910). For example, the network entity (e.g., using communication manager 150 and/or transmission component 1304, depicted in FIG. 13) may transmit a configuration that indicates a timing of a cell DTX or DRX of the network entity, as described above.

As further shown in FIG. 9, in some aspects, process 900 may include transmitting an activation DCI for the cell DTX or DRX (block 920). For example, the network entity (e.g., using communication manager 150 and/or transmission component 1304, depicted in FIG. 130) may transmit an activation DCI for the cell DTX or DRX, as described above.

Process 900 may include additional aspects, such as any single aspect or any combination of aspects described below and/or in connection with one or more other processes described elsewhere herein.

In a first aspect, the configuration indicates an absolute time, a quantity of slots, or a quantity of symbols after the activation DCI for deactivation of the cell DTX or DRX.

In a second aspect, alone or in combination with the first aspect, the configuration is an RRC configuration that is common for cell DTX configurations and cell DRX configurations.

In a third aspect, alone or in combination with one or more of the first and second aspects, the configuration is an RRC configuration that is common for cell DTX configurations or common for cell DRX configurations.

In a fourth aspect, alone or in combination with one or more of the first through third aspects, the configuration is an RRC configuration that is based at least in part on an activated cell DTX and DRX configuration.

In a fifth aspect, alone or in combination with one or more of the first through fourth aspects, the configuration is included in the activation DCI.

In a sixth aspect, alone or in combination with one or more of the first through fifth aspects, the configuration indicates a timer that starts with receiving the activation DCI.

In a seventh aspect, alone or in combination with one or more of the first through sixth aspects, the configuration indicates a delay for activation of the cell DTX or DRX.

In an eighth aspect, alone or in combination with one or more of the first through seventh aspects, the delay includes a quantity of slots or symbols.

In a ninth aspect, alone or in combination with one or more of the first through eighth aspects, the delay includes an offset indicated in the activation DCI.

In a tenth aspect, alone or in combination with one or more of the first through ninth aspects, the delay is indicated in stored configuration information.

In an eleventh aspect, alone or in combination with one or more of the first through tenth aspects, the delay is based at least in part on a timer that starts with reception of the activation DCI.

In a twelfth aspect, alone or in combination with one or more of the first through eleventh aspects, the activation DCI includes an SLIV that indicates an offset after the activation DCI and a time length for activation of the cell DTX or DRX.

In a thirteenth aspect, alone or in combination with one or more of the first through twelfth aspects, at least one of the offset or the time length is based at least in part on a quantity of slots or a quantity of symbols configured for a UE.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include an application component 1008, among other examples.

In some aspects, the apparatus 1000 may be configured to perform one or more operations described herein in connection with FIGS. 1-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1004 may be co-located with the reception component 1002 in one or more transceivers.

In some aspects, the reception component 1002 may receive a configuration that indicates a timing of a cell DTX or DRX of a network entity. The reception component 1002 may receive an activation DCI for the cell DTX or DRX. The application component 1008 may apply the configuration based at least in part on receiving the activation DCI.

The reception component 1002 may receive an activation DCI for another cell DTX or DRX, and the application component 1008 may apply the configuration by deactivating adherence to the other cell DTX or DRX based at least in part on the expiration of the timer.

The reception component 1002 may receive an activation DCI for another cell DTX or DRX. The application component 1008 may reset the timer based at least in part on reception of the activation DCI for the other cell DTX or DRX and deactivate adherence to the other cell DTX or DRX based at least in part on the expiration of the timer.

The reception component 1002 may receive a deactivation DCI. The application component 1008 may immediately deactivate adherence to the cell DTX or DRX based at least in part on the deactivation DCI. The application component 1008 may deactivate adherence to the cell DTX or DRX starting at a next active duration and inactive duration of the cell DTX or DRX based at least in part on the deactivation DCI. The application component 1008 may deactivate adherence to the cell DTX or DRX starting at a next active duration of the cell DTX or DRX based at least in part on the deactivation DCI. The application component 1008 may deactivate adherence to the cell DTX or DRX after an application delay from reception of the deactivation DCI. The application component 1008 may deactivate adherence to the cell DTX or DRX based at least in part on the deactivation DCI and a timer.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

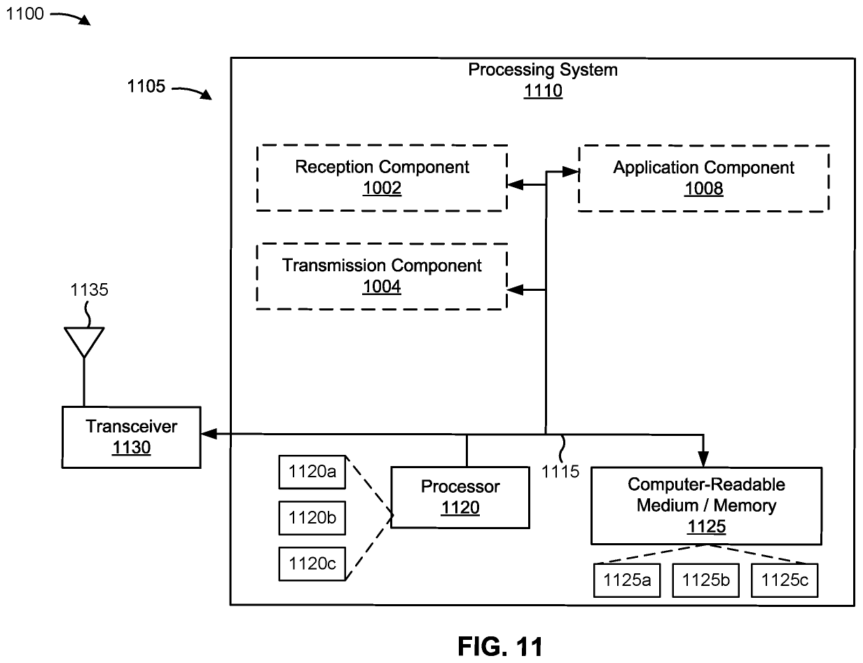

FIG. 11 is a diagram illustrating an example 1100 of a hardware implementation for an apparatus 1105 employing a processing system 1110, in accordance with the present disclosure. The apparatus 1105 may be a UE.

The processing system 1110 may be implemented with a bus architecture, represented generally by the bus 1115. The bus 1115 may include any number of interconnecting buses and bridges depending on the specific application of the processing system 1110 and the overall design constraints. The bus 1115 links together various circuits including one or more processors and/or hardware components, represented by the processor (or processing circuitry) 1120, the illustrated components, and the computer-readable medium/memory (or memory circuitry) 1125. The processor 1120 may include multiple processors, such as processor 1120a, memory 1120b, and memory 1120c. The memory 1125 may include multiple memories, such as memory 1125a, memory 1125b, and memory 1125c. The bus 1115 may also link various other circuits, such as timing sources, peripherals, voltage regulators, and/or power management circuits.

The processing system 1110 may be coupled to a transceiver 1130. The transceiver 1130 is coupled to one or more antennas 1135. The transceiver 1130 provides a means for communicating with various other apparatuses over a transmission medium. The transceiver 1130 receives a signal from the one or more antennas 1135, extracts information from the received signal, and provides the extracted information to the processing system 1110, specifically the reception component 1002. In addition, the transceiver 1130 receives information from the processing system 1110, specifically the transmission component 1004, and generates a signal to be applied to the one or more antennas 1135 based at least in part on the received information.

The processing system 1110 includes a processor 1120 coupled to a computer-readable medium/memory 1125. The processor 1120 is responsible for general processing, including the execution of software stored on the computer-readable medium/memory 1125. The software, when executed by the processor 1120, causes the processing system 1110 to perform the various functions described herein for any particular apparatus. The computer-readable medium/memory 1125 may also be used for storing data that is manipulated by the processor 1120 when executing software. The processing system further includes at least one of the illustrated components. The components may be software modules running in the processor 1120, resident/stored in the computer readable medium/memory 1125, one or more hardware modules coupled to the processor 1120, or some combination thereof.

In some aspects, the processing system 1110 may be a component of the UE 120 and may include the memory 282 and/or at least one of the TX MIMO processor 266, the RX processor 258, and/or the controller/processor 280. In some aspects, the apparatus 1105 for wireless communication includes means for receiving a configuration that indicates a timing of a cell DTX or DRX of a network entity; receiving an activation DCI for the cell DTX or DRX; and applying the configuration based at least in part on receiving the activation DCI. The aforementioned means may be one or more of the aforementioned components of the apparatus 1000 and/or the processing system 1110 of the apparatus 1105 configured to perform the functions recited by the aforementioned means. As described elsewhere herein, the processing system 1110 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 11 is provided as an example. Other examples may differ from what is described in connection with FIG. 11.

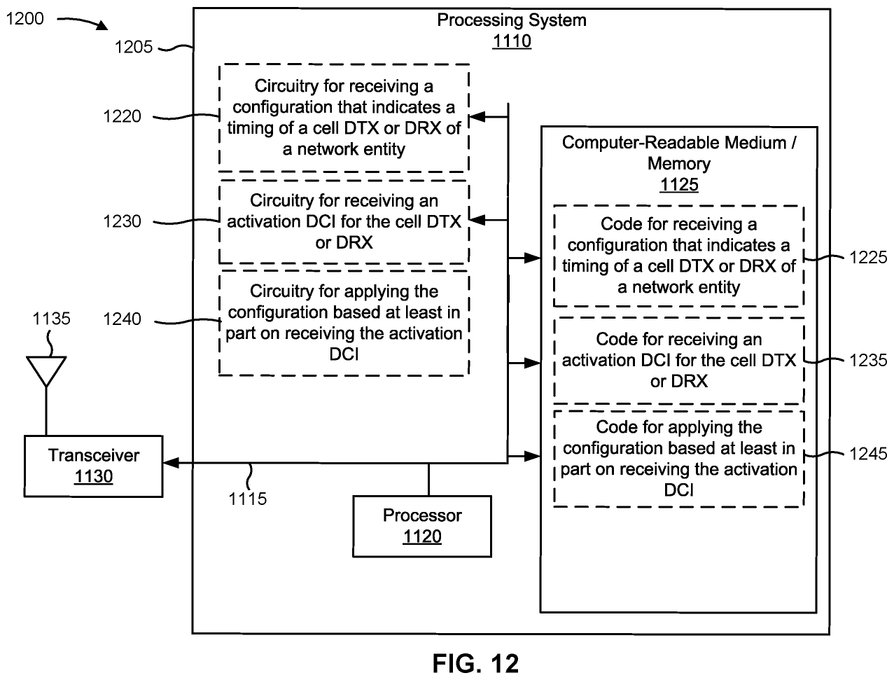

FIG. 12 is a diagram illustrating an example 1200 of an implementation of code and circuitry for an apparatus 1205, in accordance with the present disclosure. The circuitry may include processing circuitry and memory circuitry. The apparatus 1205 may be a UE, or a UE may include the apparatus 1205.

As shown in FIG. 12, the apparatus 1205 may include circuitry for receiving a configuration that indicates a timing of a cell DTX or DRX of a network entity (circuitry 1220). For example, the circuitry 1220 may enable the apparatus 1205 to receive a configuration that indicates a timing of a cell DTX or DRX of a network entity.

As shown in FIG. 12, the apparatus 1205 may include, stored in computer-readable medium 1125, code for receiving a configuration that indicates a timing of a cell DTX or DRX of a network entity (code 1225). For example, the code 1225, when executed by processor 1120, may cause processor 1120 to cause transceiver 1130 to receive a configuration that indicates a timing of a cell DTX or DRX of a network entity.

As shown in FIG. 12, the apparatus 1205 may include circuitry for receiving an activation DCI for the cell DTX or DRX (circuitry 1230). For example, the circuitry 1230 may enable the apparatus 1205 to receive an activation DCI for the cell DTX or DRX.

As shown in FIG. 12, the apparatus 1205 may include, stored in computer-readable medium 1125, code for receiving an activation DCI for the cell DTX or DRX (code 1235). For example, the code 1235, when executed by processor 1120, may cause processor 1120 to cause transceiver 1130 to receive an activation DCI for the cell DTX or DRX.

As shown in FIG. 12, the apparatus 1205 may include circuitry for applying the configuration based at least in part on receiving the activation DCI (circuitry 1240). For example, the circuitry 1240 may enable the apparatus 1205 to apply the configuration based at least in part on receiving the activation DCI.

As shown in FIG. 12, the apparatus 1205 may include, stored in computer-readable medium 1125, code for applying the configuration based at least in part on receiving the activation DCI (code 1245). For example, the code 1245, when executed by processor 1120, may cause processor 1120 to cause transceiver 1130 to apply the configuration based at least in part on receiving the activation DCI.

FIG. 12 is provided as an example. Other examples may differ from what is described in connection with FIG. 12.

FIG. 13 is a diagram of an example apparatus 1300 for wireless communication, in accordance with the present disclosure. The apparatus 1300 may be a network entity, or a network entity may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 150. The communication manager 150 may include an application component 1308, among other examples.

In some aspects, the apparatus 1300 may be configured to perform one or more operations described herein in connection with FIGS. 1-7. Additionally, or alternatively, the apparatus 1300 may be configured to perform one or more processes described herein, such as process 900 of FIG. 9. In some aspects, the apparatus 1300 and/or one or more components shown in FIG. 13 may include one or more components of the network entity described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the network entity described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, one or more modems, one or more modulators, one or more transmit MIMO processors, one or more transmit processors, one or more controllers/processors, one or more memories, or a combination thereof, of the network entity described in connection with FIG. 2. In some aspects, the transmission component 1304 may be co-located with the reception component 1302 in one or more transceivers.

The transmission component 1304 may transmit a configuration that indicates a timing of a cell DTX or DRX of the network entity. The transmission component 1304 may transmit an activation DCI for the cell DTX or DRX.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

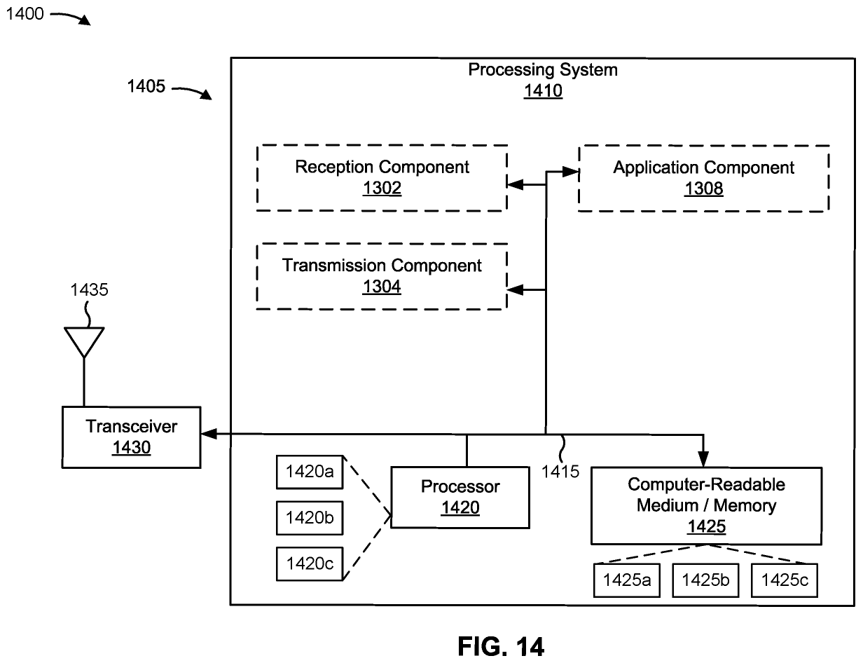

FIG. 14 is a diagram illustrating an example 1400 of a hardware implementation for an apparatus 1405 employing a processing system 1410, in accordance with the present disclosure. The apparatus 1405 may be a network entity.

The processing system 1410 may be implemented with a bus architecture, represented generally by the bus 1415. The bus 1415 may include any number of interconnecting buses and bridges depending on the specific application of the processing system 1410 and the overall design constraints. The bus 1415 links together various circuits including one or more processors and/or hardware components, represented by the processor (or processing circuitry) 1420, the illustrated components, and the computer-readable medium/memory (or memory circuitry) 1425. The processor 1420 may include multiple processors, such as processor 1420a, memory 1420b, and memory 1420c. The memory 1425 may include multiple memories, such as memory 1425a, memory 1425b, and memory 1425c. The bus 1415 may also link various other circuits, such as timing sources, peripherals, voltage regulators, and/or power management circuits.

The processing system 1410 may be coupled to a transceiver 1430. The transceiver 1430 is coupled to one or more antennas 1435. The transceiver 1430 provides a means for communicating with various other apparatuses over a transmission medium. The transceiver 1430 receives a signal from the one or more antennas 1435, extracts information from the received signal, and provides the extracted information to the processing system 1410, specifically the reception component 1302. In addition, the transceiver 1430 receives information from the processing system 1410, specifically the transmission component 1304, and generates a signal to be applied to the one or more antennas 1435 based at least in part on the received information.

The processing system 1410 includes a processor 1420 coupled to a computer-readable medium/memory 1425. The processor 1420 is responsible for general processing, including the execution of software stored on the computer-readable medium/memory 1425. The software, when executed by the processor 1420, causes the processing system 1410 to perform the various functions described herein for any particular apparatus. The computer-readable medium/memory 1425 may also be used for storing data that is manipulated by the processor 1420 when executing software. The processing system further includes at least one of the illustrated components. The components may be software modules running in the processor 1420, resident/stored in the computer readable medium/memory 1425, one or more hardware modules coupled to the processor 1420, or some combination thereof.

In some aspects, the processing system 1410 may be a component of the network node 110 and may include the memory 242 and/or at least one of the TX MIMO processor 230, the RX processor 238, and/or the controller/processor 240. In some aspects, the apparatus 1405 for wireless communication includes means for transmitting a configuration that indicates a timing of a cell DTX or DRX of the network entity; and transmitting an activation DCI for the cell DTX or DRX. The aforementioned means may be one or more of the aforementioned components of the apparatus 1300 and/or the processing system 1410 of the apparatus 1405 configured to perform the functions recited by the aforementioned means. As described elsewhere herein, the processing system 1410 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 14 is provided as an example. Other examples may differ from what is described in connection with FIG. 14.

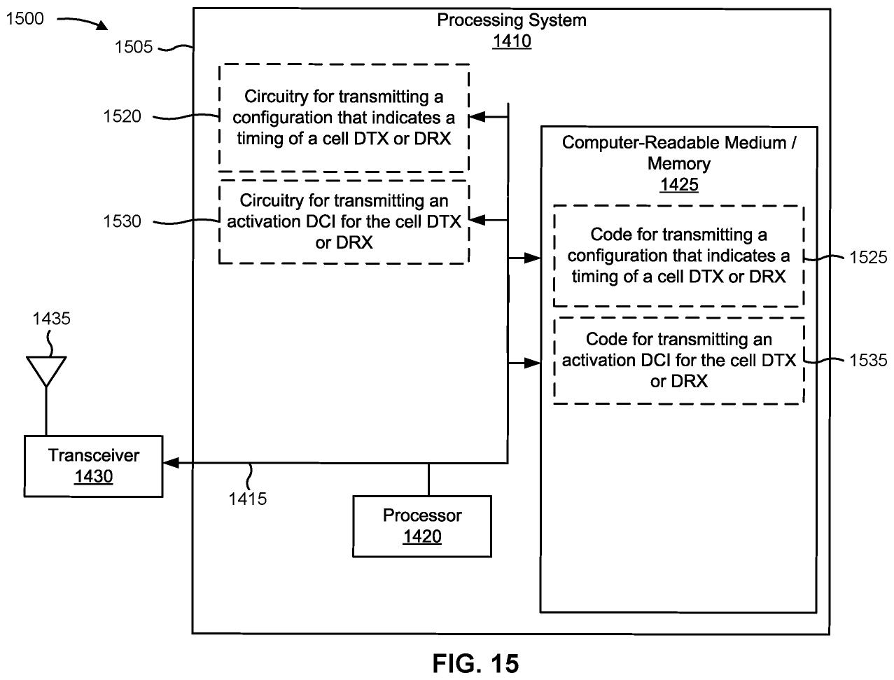

FIG. 15 is a diagram illustrating an example 1500 of an implementation of code and circuitry for an apparatus 1505, in accordance with the present disclosure. The circuitry may include processing circuitry and memory circuitry. The apparatus 1505 may be a network entity, or a network entity may include the apparatus 1505.

As shown in FIG. 15, the apparatus 1505 may include circuitry for transmitting a configuration that indicates a timing of a cell DTX or DRX of the network entity (circuitry 1520). For example, the circuitry 1520 may enable the apparatus 1505 to transmit a configuration that indicates a timing of a cell DTX or DRX of the network entity.

As shown in FIG. 15, the apparatus 1505 may include, stored in computer-readable medium 1425, code for transmitting a configuration that indicates a timing of a cell DTX or DRX of the network entity (code 1525). For example, the code 1525, when executed by processor 1420, may cause processor 1420 to cause transceiver 1430 to transmit a configuration that indicates a timing of a cell DTX or DRX of the network entity.

As shown in FIG. 15, the apparatus 1505 may include circuitry for transmitting an activation DCI for the cell DTX or DRX (circuitry 1530). For example, the circuitry 1530 may enable the apparatus 1505 to transmit an activation DCI for the cell DTX or DRX.

As shown in FIG. 15, the apparatus 1505 may include, stored in computer-readable medium 1425, code for transmitting an activation DCI for the cell DTX or DRX (code 1535). For example, the code 1535, when executed by processor 1420, may cause processor 1420 to cause transceiver 1430 to transmit an activation DCI for the cell DTX or DRX.

FIG. 15 is provided as an example. Other examples may differ from what is described in connection with FIG. 15.

The following provides an overview of some Aspects of the present disclosure:

Aspect 1: A method of wireless communication performed at a user equipment (UE), comprising: receiving a configuration that indicates a timing of a cell discontinuous transmission (DTX) or discontinuous reception (DRX) of a network entity; receiving an activation downlink control information (DCI) for the cell DTX or DRX; and applying the configuration based at least in part on receiving the activation DCI.

Aspect 2: The method of Aspect 1, wherein the configuration indicates an absolute time for deactivation of the cell DTX or DRX, and wherein applying the configuration includes deactivating adherence to the cell DTX or DRX at the absolute time.

Aspect 3: The method of any of Aspects 1-2, wherein the configuration indicates a quantity of slots after the activation DCI for deactivation of the cell DTX or DRX, and wherein applying the configuration includes deactivating adherence to the cell DTX or DRX after a slot in which the activation DCI is received, after a subframe in which the activation DCI is received, or after an end of a monitoring occasion in which the activation DCI is received.

Aspect 4: The method of any of Aspects 1-2, wherein the configuration indicates a quantity of symbols after the activation DCI for deactivation of the cell DTX or DRX, and wherein applying the configuration includes deactivating adherence to the cell DTX or DRX the quantity of symbols after a symbol in which the activation DCI is received, after a subframe in which the activation DCI is received, or after an end of a monitoring occasion in which the activation DCI is received.

Aspect 5: The method of any of Aspects 1-4, wherein the configuration is a radio resource control configuration that is common for cell DTX configurations and cell DRX configurations.

Aspect 6: The method of any of Aspects 1-4, wherein the configuration is a radio resource control configuration that is common for cell DTX configurations or common for cell DRX configurations.

Aspect 7: The method of any of Aspects 1-4, wherein the configuration is a radio resource control (RRC) configuration that is based at least in part on an activated cell DTX and DRX configuration.

Aspect 8: The method of any of Aspects 1-7, wherein the configuration is included in the activation DCI.

Aspect 9: The method of any of Aspects 1-8, wherein the configuration indicates a timer that starts with reception of the activation DCI, and wherein applying the configuration includes deactivating adherence to the cell DTX or DRX based at least in part on expiration of the timer.

Aspect 10: The method of Aspect 9, further comprising receiving an activation DCI for another cell DTX or DRX, and wherein applying the configuration includes deactivating adherence to the other cell DTX or DRX based at least in part on the expiration of the timer.

Aspect 11: The method of Aspect 9, further comprising: receiving an activation DCI for another cell DTX or DRX; and resetting the timer based at least in part on reception of the activation DCI for the other cell DTX or DRX, wherein applying the configuration includes deactivating adherence to the other cell DTX or DRX based at least in part on the expiration of the timer.

Aspect 12: The method of any of Aspects 1-11, wherein the configuration indicates a delay for activation of the cell DTX or DRX, and wherein applying the configuration includes activating adherence to the cell DTX or DRX after the delay and deactivating adherence to the cell DTX or DRX based at least in part on the delay and the configuration.

Aspect 13: The method of Aspect 12, wherein the delay includes a quantity of slots or symbols.

Aspect 14: The method of Aspect 12, wherein the delay includes an offset indicated in the activation DCI.

Aspect 15: The method of Aspect 12, wherein the delay is indicated in stored configuration information.

Aspect 16: The method of Aspect 12, wherein the delay is based at least in part on a timer that starts with reception of the activation DCI.

Aspect 17: The method of any of Aspects 1-16, further comprising: receiving a deactivation DCI; and immediately deactivating adherence to the cell DTX or DRX based at least in part on the deactivation DCI.

Aspect 18: The method of Aspect 17, wherein immediately deactivating adherence to the cell DTX or DRX include deactivating adherence to the cell DTX or DRX starting at a symbol or slot at which the deactivation DCI is decoded.

Aspect 19: The method of any of Aspects 1-16, further comprising: receiving a deactivation DCI; and deactivating adherence to the cell DTX or DRX starting at a next active duration and inactive duration of the cell DTX or DRX based at least in part on the deactivation DCI.

Aspect 20: The method of any of Aspects 1-16, further comprising: receiving a deactivation DCI; and deactivating adherence to the cell DTX or DRX starting at a next active duration of the cell DTX or DRX based at least in part on the deactivation DCI.

Aspect 21: The method of any of Aspects 1-16, further comprising: receiving a deactivation DCI; and deactivating adherence to the cell DTX or DRX after an application delay from reception of the deactivation DCI.

Aspect 22: The method of any of Aspects 1-16, further comprising: receiving a deactivation DCI; and deactivating adherence to the cell DTX or DRX based at least in part on the deactivation DCI and a timer.

Aspect 23: The method of any of Aspects 1-22, wherein the activation DCI includes a start and length indication value (SLIV) that indicates an offset after the activation DCI and a time length for activation of the cell DTX or DRX, and wherein applying the configuration includes activating adherence to the cell DTX or DRX at the offset and deactivating adherence to the cell DTX and DRX after the time length.

Aspect 24: The method of Aspect 23, wherein at least one of the offset or the time length is based at least in part on a quantity of slots or a quantity of symbols configured for the UE.

Aspect 25: An apparatus for wireless communication at a user equipment (UE), comprising: one or more memories; and one or more processors coupled to the one or more memories, the one or more processors configured to cause the UE to: receive a configuration that indicates a timing of a cell discontinuous transmission (DTX) or discontinuous reception (DRX) of a network entity; receive an activation downlink control information (DCI) for the cell DTX or DRX; and apply the configuration based at least in part on receiving the activation DCI.

Aspect 26: The apparatus of Aspect 25, wherein the one or more processors are configured, individually or collectively, to cause the UE to: receive a configuration that indicates a timing of a cell discontinuous transmission (DTX) or discontinuous reception (DRX) of a network entity; receive an activation downlink control information (DCI) for the cell DTX or DRX; and apply the configuration based at least in part on receiving the activation DCI.

Aspect 27: An apparatus for wireless communication at a user equipment (UE), comprising: a processing system that includes processor circuitry and memory circuitry that stores code and is coupled with the processor circuitry, the processing system configured to cause the UE to perform the method of one or more of Aspects 1-26.

Aspect 28: A method of wireless communication performed at a network entity, comprising: transmitting a configuration that indicates a timing of a cell discontinuous transmission (DTX) or discontinuous reception (DRX) of the network entity; and transmitting an activation downlink control information (DCI) for the cell DTX or DRX.

Aspect 29: The method of Aspect 28, wherein the configuration indicates an absolute time, a quantity of slots, or a quantity of symbols after the activation DCI for deactivation of the cell DTX or DRX.

Aspect 30: The method of any of Aspects 28-29, wherein the configuration is a radio resource control configuration that is common for cell DTX configurations and cell DRX configurations.

Aspect 31: The method of any of Aspects 28-29, wherein the configuration is a radio resource control configuration that is common for cell DTX configurations or common for cell DRX configurations.

Aspect 32: The method of any of Aspects 28-29, wherein the configuration is a radio resource control (RRC) configuration that is based at least in part on an activated cell DTX and DRX configuration.

Aspect 33: The method of any of Aspects 28-32, wherein the configuration is included in the activation DCI.

Aspect 34: The method of any of Aspects 28-33, wherein the configuration indicates a timer that starts with receiving the activation DCI.

Aspect 35: The method of any of Aspects 28-34, wherein the configuration indicates a delay for activation of the cell DTX or DRX.

Aspect 36: The method of Aspect 35, wherein the delay includes a quantity of slots or symbols.

Aspect 37: The method of Aspect 35, wherein the delay includes an offset indicated in the activation DCI.

Aspect 38: The method of Aspect 35, wherein the delay is indicated in stored configuration information.

Aspect 39: The method of Aspect 35, wherein the delay is based at least in part on a timer that starts with reception of the activation DCI.

Aspect 40: The method of any of Aspects 28-39, wherein the activation DCI includes a start and length indication value (SLIV) that indicates an offset after the activation DCI and a time length for activation of the cell DTX or DRX.

Aspect 41: The method of Aspect 40, wherein at least one of the offset or the time length is based at least in part on a quantity of slots or a quantity of symbols configured for a user equipment.

Aspect 42: An apparatus for wireless communication at a user equipment (UE), comprising: one or more memories; and one or more processors coupled to the one or more memories, the one or more processors configured to cause the UE to: transmit a configuration that indicates a timing of a cell discontinuous transmission (DTX) or discontinuous reception (DRX) of the network entity; and transmit an activation downlink control information (DCI) for the cell DTX or DRX.

Aspect 43: The apparatus of Aspect 42, wherein the one or more processors are configured, individually or collectively, to cause the UE to: transmit a configuration that indicates a timing of a cell discontinuous transmission (DTX) or discontinuous reception (DRX) of the network entity; and transmit an activation downlink control information (DCI) for the cell DTX or DRX.

Aspect 44: An apparatus for wireless communication at a network entity, comprising: a processing system that includes processor circuitry and memory circuitry that stores code and is coupled with the processor circuitry, the processing system configured to cause the network entity to perform the method of one or more of Aspects 27-43.

Aspect 45: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-43.

Aspect 46: An apparatus for wireless communication at a device, the apparatus comprising one or more memories and one or more processors coupled to the one or more memories, the one or more processors configured to cause the device to perform the method of one or more of Aspects 1-43.

Aspect 47: An apparatus for wireless communication, the apparatus comprising at least one means for performing the method of one or more of Aspects 1-43.

Aspect 48: A non-transitory computer-readable medium storing code for wireless communication, the code comprising instructions executable by one or more processors to perform the method of one or more of Aspects 1-43.

Aspect 49: A non-transitory computer-readable medium storing a set of instructions for wireless communication, the set of instructions comprising one or more instructions that, when executed by one or more processors of a device, cause the device to perform the method of one or more of Aspects 1-43.

Aspect 50: A device for wireless communication, the device comprising a processing system that includes one or more processors and one or more memories coupled with the one or more processors, the processing system configured to cause the device to perform the method of one or more of Aspects 1-43.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors coupled to the one or more memories and configured to cause the UE to:
receive a configuration that indicates a timing of a cell discontinuous transmission (DTX) or discontinuous reception (DRX) of a network entity;
receive an activation downlink control information (DCI) for the cell DTX or DRX; and
apply the configuration based at least in part on receiving the activation DCI.

2. The apparatus of claim 1, wherein the configuration indicates an absolute time for deactivation of the cell DTX or DRX, and wherein the one or more processors, to apply the configuration, are configured to cause the UE to deactivate adherence to the cell DTX or DRX at the absolute time.

3. The apparatus of claim 1, wherein the configuration indicates a quantity of slots after the activation DCI for deactivation of the cell DTX or DRX, and wherein the one or more processors, to apply the configuration, are configured to cause the UE to deactivate adherence to the cell DTX or DRX after a slot in which the activation DCI is received, after a subframe in which the activation DCI is received, or after an end of a monitoring occasion in which the activation DCI is received.

4. The apparatus of claim 1, wherein the configuration indicates a quantity of symbols after the activation DCI for deactivation of the cell DTX or DRX, and wherein the one or more processors, to apply the configuration, are configured to cause the UE to deactivate adherence to the cell DTX or DRX the quantity of symbols after a symbol in which the activation DCI is received, after a subframe in which the activation DCI is received, or after an end of a monitoring occasion in which the activation DCI is received.

5. The apparatus of claim 1, wherein the configuration is a radio resource control configuration that is common for cell DTX configurations and cell DRX configurations.

6. The apparatus of claim 1, wherein the configuration is a radio resource control configuration that is common for cell DTX configurations or common for cell DRX configurations.

7. The apparatus of claim 1, wherein the configuration is a radio resource control (RRC) configuration that is based at least in part on an activated cell DTX and DRX configuration.

8. The apparatus of claim 1, wherein the configuration is included in the activation DCI.

9. The apparatus of claim 1, wherein the configuration indicates a timer that starts with reception of the activation DCI, and wherein the one or more processors, to apply the configuration, are configured to cause the UE to deactivate adherence to the cell DTX or DRX based at least in part on expiration of the timer.

10. The apparatus of claim 9, wherein the one or more processors are configured to cause the UE to receive an activation DCI for another cell DTX or DRX, and wherein the one or more processors, to apply the configuration, are configured to cause the UE to deactivate adherence to the other cell DTX or DRX based at least in part on the expiration of the timer.

11. The apparatus of claim 9, wherein the one or more processors are configured to cause the UE to:
receive an activation DCI for another cell DTX or DRX; and
reset the timer based at least in part on reception of the activation DCI for the other cell DTX or DRX, wherein the one or more processors, to apply the configuration, are configured to cause the UE to deactivate adherence to the other cell DTX or DRX based at least in part on the expiration of the timer.

12. The apparatus of claim 1, wherein the configuration indicates a delay for activation of the cell DTX or DRX, and wherein the one or more processors, to apply the configuration, are configured to cause the UE to activate adherence to the cell DTX or DRX after the delay and deactivate adherence to the cell DTX or DRX based at least in part on the delay and the configuration.

13. The apparatus of claim 12, wherein the delay includes a quantity of slots or symbols.

14. The apparatus of claim 12, wherein the delay includes an offset indicated in the activation DCI.

15. The apparatus of claim 12, wherein the delay is indicated in stored configuration information.

16. The apparatus of claim 12, wherein the delay is based at least in part on a timer that starts with reception of the activation DCI.

17. The apparatus of claim 1, wherein the one or more processors are configured to cause the UE to:
receive a deactivation DCI; and
immediately deactivate adherence to the cell DTX or DRX based at least in part on the deactivation DCI.

18. The apparatus of claim 17, wherein the one or more processors, to immediately deactivate adherence to the cell DTX or DRX, are configured to cause the UE to deactivate adherence to the cell DTX or DRX starting at a symbol or slot at which the deactivation DCI is decoded.

19. The apparatus of claim 1, wherein the one or more processors are configured to cause the UE to:
receive a deactivation DCI; and
deactivate adherence to the cell DTX or DRX starting at a next active duration and inactive duration of the cell DTX or DRX based at least in part on the deactivation DCI.

20. The apparatus of claim 1, wherein the one or more processors are configured to cause the UE to:
receive a deactivation DCI; and
deactivate adherence to the cell DTX or DRX starting at a next active duration of the cell DTX or DRX based at least in part on the deactivation DCI.

21. The apparatus of claim 1, wherein the one or more processors are configured to cause the UE to:
receive a deactivation DCI; and
deactivate adherence to the cell DTX or DRX after an application delay from reception of the deactivation DCI.

22. The apparatus of claim 1, wherein the one or more processors are configured to cause the UE to:
receive a deactivation DCI; and
deactivate adherence to the cell DTX or DRX based at least in part on the deactivation DCI and a timer.

23. The apparatus of claim 1, wherein the activation DCI includes a start and length indication value (SLIV) that indicates an offset after the activation DCI and a time length for activation of the cell DTX or DRX, and wherein the one or more processors, to apply the configuration, are configured to cause the UE to activate adherence to the cell DTX or DRX at the offset and deactivating adherence to the cell DTX and DRX after the time length.

24. The apparatus of claim 23, wherein at least one of the offset or the time length is based at least in part on a quantity of slots or a quantity of symbols configured for the UE.

25. An apparatus for wireless communication at a network entity, comprising:
one or more memories; and
one or more processors coupled to the one or more memories and configured to cause the network entity to:
transmit a configuration that indicates a timing of a cell discontinuous transmission (DTX) or discontinuous reception (DRX) of the network entity; and
transmit an activation downlink control information (DCI) for the cell DTX or DRX.

26. The apparatus of claim 25, wherein the configuration indicates an absolute time, a quantity of slots, or a quantity of symbols after the activation DCI for deactivation of the cell DTX or DRX.

27. The apparatus of claim 25, wherein the configuration indicates a timer that starts with receiving the activation DCI or a delay for activation of the cell DTX or DRX.

28. The apparatus of claim 25, wherein the activation DCI includes a start and length indication value (SLIV) that indicates an offset after the activation DCI and a time length for activation of the cell DTX or DRX.

29. A method of wireless communication performed at a user equipment (UE), comprising:
receiving a configuration that indicates a timing of a cell discontinuous transmission (DTX) or discontinuous reception (DRX) of a network entity;
receiving an activation downlink control information (DCI) for the cell DTX or DRX; and
applying the configuration based at least in part on receiving the activation DCI.

30. A method of wireless communication performed at a network entity, comprising:
transmitting a configuration that indicates a timing of a cell discontinuous transmission (DTX) or discontinuous reception (DRX) of the network entity; and
transmitting an activation downlink control information (DCI) for the cell DTX or DRX.
